(19) United States
(12) Patent Application Publication
(10) Pub. No.: US 2008/0104259 A1
(43) Pub. Date: May 1, 2008

(54) Methods and systems for communicating with storage devices in a storage system

(76) Inventors: Marc LeFevre, Eagle, ID (US); George Shin, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/589,543

(22) Filed: Oct. 28, 2006

(51) Int. Cl. G06F 15/16

(52) U.S. Cl. 709/228; 709/229

(57) ABSTRACT

Embodiments include methods, apparatus, and systems for communicating with storage devices in a storage system. One embodiment includes calculating a time for a host computer to abort data requests in a storage network; receiving a data request at a storage device from the host computer; and sending the host computer a notice of a status of the data request before the time expires and the host computer aborts the data request.

### BACKGROUND

In storage systems, host computers send input/output (I/O) requests to storage arrays to perform reads, writes, and maintenance. The storage arrays typically process the requests in a fraction of a second. In some instances, numerous hosts direct large numbers of requests toward a single storage array. If the array is not able to immediately process the requests, then the requests are queued.

Hosts computers do not indefinitely wait for the storage array to process requests. If the storage array does not process the request within a predetermined amount of time, then a time-out occurs. When a time-out occurs the host can experience a failover event if multi-path software is being used to manage command delivery via multiple hardware paths to the storage array.

A failover event in a host produces undesirable results. In some instances, the host aborts the request and sends a new request. If the storage array is still busy, then the new request is added to the queue and the process of timing out, aborting, and resending can keep repeating. In other instances, the host may have multi-path software that enables it to resend the request along a different path to the storage array. The host selects a different I/O path and resends the same request to the storage array. Even though the storage array receives the request at a different port, the array may still be too busy to immediately process the request. Further resources at the array are consumed if the request is queued and the host again times-out.

Once the host sends a request to the array, the host is not informed of the status of the request while it is pending in the array. The host is not able to determine if the request is queued, being processed, or will not be granted because of a hardware problem. At the host end, users are often presented with a spinning hour glass but are not provided any further detail information.

### BRIEF DESCRIPTION OF THE DRAWINGS

FIG. 1 is a block diagram of a storage system in accordance with an exemplary embodiment of the present invention.

FIG. 2 is a flow diagram for obtaining timeout information about a host computer in accordance with an exemplary embodiment of the present invention.

FIG. 3 is a flow diagram for notifying a host before a timeout period for a data request expires in accordance with an exemplary embodiment of the present invention.

### DETAILED DESCRIPTION

Embodiments in accordance with the present invention are directed to apparatus, systems, and methods for communicating with storage devices in storage systems. One embodiment is an adaptive storage system that allows storage devices to predict and then accommodate different timeout times from various host computers.

Host computers run different operating systems and thus make read and write requests to storage devices with varying expectations for command completion times. These expectations generally do not take into account current workloads in the storage device. If commands do not complete within expected times, multi-path software in the host may assume that the hardware servicing those requests has failed and initiate failover actions to alternate hardware paths. These failover events take time and unnecessarily reduce the overall performance of the storage system. Variations in workload for storage systems are common in multi-initiator environments. When workload peaks occur, command response times can exceed timeouts in some hosts.

One exemplary embodiment provides an adaptive storage system that tracks various parameters associated with storage device workload and response times. In turn, the storage system responds to host requests that are not completed in a timely fashion, example completed before a timeout at the host occurs. By way of example, the storage system monitors the host computer and derives timeout values or timeout periods for each host. In one exemplary embodiment, the storage system records timestamps for all requests as they arrive. The storage system then observes when command abort operations and failover events occur at one or more host computers logged to the storage system. This information is used to predict when a host will timeout or abort an operation. Before such a timeout or abort occurs, the storage system sends the host a notice, example informing the host that the I/O request is still pending or being processed.

Once the storage system has acquired timeout values or periods for a host, then the storage system can take preemptive action before the host actually experiences a timeout and failover. In other words, the storage system takes an action before the timer at the host expires while a host I/O requests is pending. In one exemplary embodiment, this action includes, but is not limited to, notifying the host that the storage device is busy, has a full queue, or is processing the request but not yet completed it, to name a few examples.

In short, the host is notified that the communication channel to the storage device is functional and that the storage device is aware of the request. Since hosts have notification or acknowledgement of the pending request, the host will not initiate a failover event. Hosts are less prone to initiate multi-path software and re-send I/O requests down an alternate path to the same storage device. Thus, exemplary embodiments reduce the number of unnecessary failover events while at the same time maintain a level of performance that is acceptable to hosts.

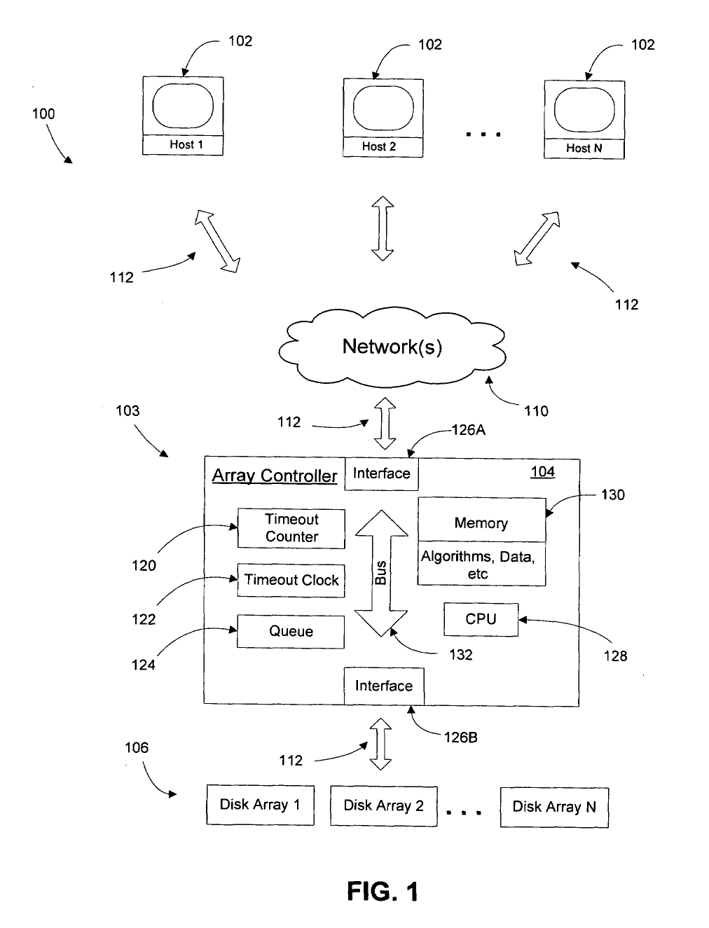

FIG. 1 is a block diagram of an exemplary distributed file or storage system 100 in accordance with an exemplary embodiment of the invention. By way of example, the system is a storage area network (SAN) that includes a plurality of host computers 102 and one or more storage devices 103 that include one or more storage controllers 104 (shown by way of example as an array controller), and a plurality of storage devices 106 (shown by way of example as disk array 1 to disk array N).

The host computers (shown as host 1 to host N) are coupled to the array controller 104 through one or more networks 110. For instance, the hosts communicate with the array controller using a small computer system interface (SCSI) or other interface/commands. Further, by way of example, network 110 includes one or more of the internet, local area network (LAN), wide area network (WAN), etc. Communications links 112 are shown in the figure to represent communication paths or couplings between the hosts, controller, and storage devices.

In one exemplary embodiment, the array controller 104 and disk arrays 106 are network attached devices providing random access memory (RAM) and/or disk space (for storage and as virtual RAM) and/or some other form of storage such as magnetic memory (example, tapes), micromechanical systems (MEMS), or optical disks, to name a few examples. Typically, the array controller and disk arrays include larger amounts of RAM and/or disk space and one or more specialized devices, such as network disk drives or disk drive arrays, (example, redundant array of independent disks (RAID)), high speed tape, magnetic random access memory (MRAM) systems or other devices, and combinations thereof. In one exemplary embodiment, the array controller 104 and disk arrays 106 are memory nodes that include one or more servers.

The storage controller 104 manages various data storage and retrieval operations. Storage controller 104 receives I/O requests or commands from the host computers 102, such as data read requests, data write requests, maintenance requests, etc. Storage controller 104 handles the storage and retrieval of data on the multiple disk arrays 106. In one exemplary embodiment, storage controller 104 is a separate device or may be part of a computer system, such as a server. Additionally, the storage controller 104 may be located with, proximate, or a great geographical distance from the disk arrays 106.

The array controller 104 includes numerous electronic devices, circuit boards, electronic components, etc. By way of example, the array controller 104 includes a timeout counter 120, a timeout clock 122, a queue 124, one or more interfaces 126, one or more processors 128 (shown by way of example as a CPU, central processing unit), and memory 130. CPU 128 performs operations and tasks necessary to manage the various data storage and data retrieval requests received from host computers 102. For instance, processor 128 is coupled to a host interface 126A that provides a bidirectional data communication interface to one or more host computers 102. Processor 128 is also coupled to an array interface 126B that provides a bidirectional data communication interface to the disk arrays 106.

Memory 130 is also coupled to processor 128 and stores various information used by processor when carrying out its tasks. By way of example, memory 130 includes one or more of volatile memory, non-volatile memory, or a combination of volatile and non-volatile memory. The memory 130, for example, stores applications, data, control programs, algorithms (including software to implement or assist in implementing embodiments in accordance with the present invention), and other data associated with the storage device. The processor 128 communicates with memory 130, interfaces 126, and the other components via one or more buses 132.

In at least one embodiment, the storage devices are fault tolerant by using existing replication, disk logging, and disk imaging systems and other methods including, but not limited to, one or more levels of redundant array of inexpensive disks (RAID). Replication provides high availability when one or more of the disk arrays crash or otherwise fail. Further, in one exemplary embodiment, the storage devices provide memory in the form of a disk or array of disks where data items to be addressed are accessed as individual blocks stored in disks (example, 512, 1024, 4096, etc. . . . bytes each) or stripe fragments (4K, 16K, 32K, etc. . . . each).

In one exemplary embodiment, one or more timeout clocks 122 track times required for a host to timeout and abort an outstanding I/O request. For instance, a timeout clock commences when the array controller receives an I/O request and stops when the array controller receives notification that the corresponding host aborted the request.

In one exemplary embodiment, the host computers do not indefinitely wait for the storage array to process requests. If the storage array does not process the request within a predetermined amount of time, then a time-out occurs and the host experiences a failover. The host computer includes a timer that commences when the host initiates the request. For instance, if the array controller 104 is too busy to process an outstanding command, the command is queued in queue 124. Once the timer at the host expires (i.e., the time period allocated for the array to complete the request expires), the host aborts the request. In one exemplary embodiment, the timeout clock records timestamps as host requests are received at the storage device. The timeout counter 120 counts the number of timeout events occurring at one or more of the hosts.

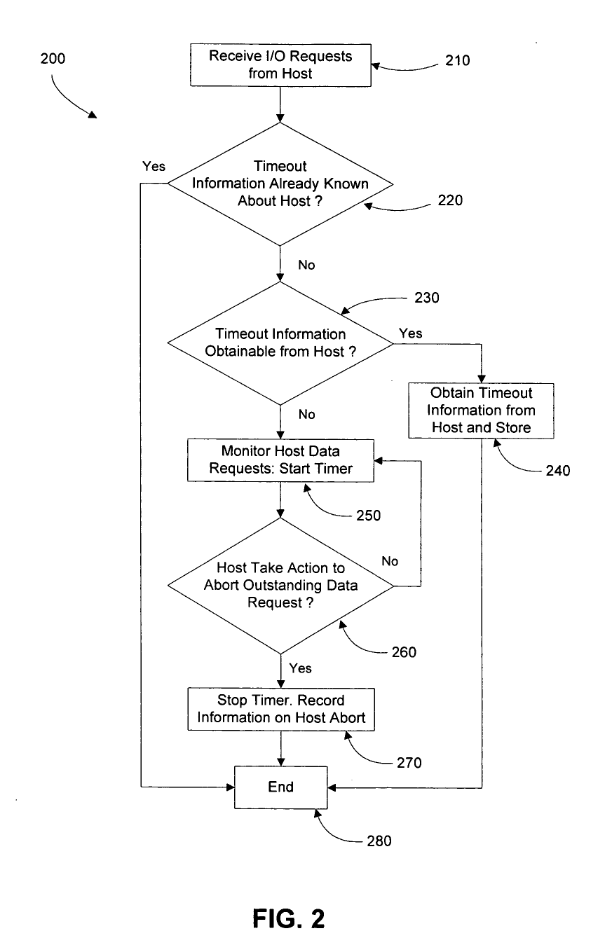

FIG. 2 is a flow diagram 200 for obtaining timeout information about a host computer in accordance with an exemplary embodiment of the present invention. One exemplary embodiment is constructed in software that executes controller operations in the storage device. For example, the storage device observes the arrival of data access requests from all hosts. The storage device also observes actions that hosts take to abort outstanding requests and is able to observe when those aborted requests are re-sent through alternate paths to the storage device. Timestamps are recorded for all host requests when such requests arrive.

According to block 210, the storage device receives I/O requests from a host. Once the host is identified, the storage device asks a question according to block 220: Is timeout information already known for the host? For instance, the storage device may have already received I/O requests from the same host and already calculated or obtained timeout information for the host. This information can be stored in the storage device, such as in the array controller.

If the answer to this question is “yes” and the storage device already has sufficient timeout information for the host, then flow proceeds to block 280 and ends. If timeout information is not known or if the storage device desires to update or verify existing timeout information, then flow proceeds to block 230.

According to block 230, a question is asked: Is the timeout information obtainable from the host? In some embodiments, the storage device can obtain the timeout information from host. For instance, the storage device queries the host for timeout settings for the host to initiate an abort or failover. If the host is able to provide such information to the storage device, then this information is provided and stored in the storage device according to block 240. If the answer to this question is “no” then flow proceeds to block 250.

According to block 250, the storage device monitors the host data requests to determine timeouts for the host. In one exemplary embodiment, the storage device records timestamps for all hosts requests when such requests arrive.

According to block 260, a question is asked: Did the host take action to abort the outstanding request? In one embodiment, the storage device determines whether a timeout occurs at the host. By way of example, when a timeout occurs at the host, the host aborts the outstanding I/O request by sending a notification of the abort to the storage device. In turn, the storage device calculates the timeout period for the host by evaluating a difference in time between the timestamp and receipt of the notification. With this information, the storage device can predict the timeout period for the host.

According to block 270, when the storage device receives notification of the host abort, the storage devices stops a timer (example, records a second timestamp) and stores the timeout information for the host.

In one exemplary embodiment, whenever a request is aborted by a host, the storage device records one or more of the following information:
1. Identity of the host that sent the I/O request.
2. The type of request sent (example, read request, write request, or maintenance request).
3. Request parameters such as transfer length requested, queue management tags, (if any), logical unit being accessed, and whether a Force Unit Access option was being requested.
4. Whether the aborted request was part of a serial access pattern, random access pattern, or neither.
5. The amount of time that the request was outstanding (i.e., not completed) in the storage system before it was aborted.
6. What the internal state of the request was when it was aborted.
7. How busy the storage device is at the time of the abort.

In one exemplary embodiment, as long as the host is registered (i.e., logged in), these parameters are stored in memory. Once a sufficient amount of data is collected, the storage device predicts which requests from hosts have short timeouts. If these requests languish in the storage system due to high workloads, the storage system can determine whether to abort the request internally and return a status to the host. This status effectively instructs the host that the storage system is functioning normally but was not able to complete the request in a timely fashion (i.e., before expiration of the timeout period). Further, this status implies that sending the request again after a short delay maximizes a likelihood of having the request successfully completed.

Flow then ends at block 280. In one exemplary embodiment, the storage device can repeatedly calculate or predict timeouts for the same host. As new requests and subsequent aborts are encountered, new timeouts are generated. These new timeout values are compared with existing values (example, values previously calculated), and the existing values are updated or refined to improve accuracy.

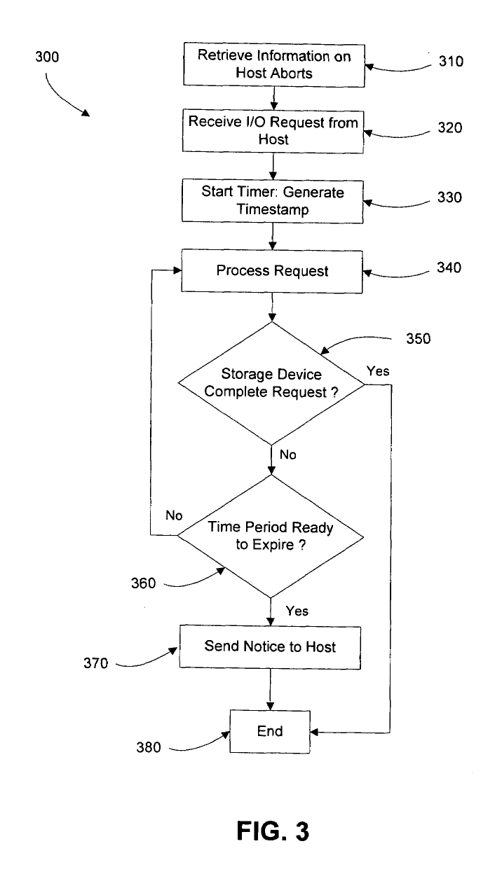

FIG. 3 is a flow diagram 300 for notifying a host before a timeout period for a data request expires in accordance with an exemplary embodiment of the present invention. According to block 310, after host has logged in, the storage device retrieves information on the abort times of the host. Block 310 thus assumes the storage device has obtained or predicted such timeout information. Such information can be already stored in the storage device, obtained directly from the host, or concurrently calculated while the host is logged in and making I/O requests.

According to block 320, the storage device receives an I/O request from the host. Receipt of this I/O request causes the storage device to start a timer or generate a timestamp. In other words, the storage device records the time of receipt for the request from the host.

According to block 340, the storage device begins to process the request. In one exemplary embodiment, the array controller controls the storage arrays. The controller receives the I/O requests and controls the arrays to respond to those requests. If the storage device cannot process current requests, then the controller queues host requests in a queue until they can be processed.

According to block 350, a question is asked: Did the storage device complete the request? If the answer to this question is “yes” then flow ends at block 380. If the answer to this question is “no” then flow proceeds to block 360. Here, a question is asked: Is the time period at the storage device ready to expire? In other words, is a timeout event ready to occur at the host that sent the I/O request? If the answer to this question is “no” then flow proceeds back to block 340. Here, the request is further processed or held in queue. If the answer to this question is “yes” then flow proceeds to block 370.

If the timeout period is ready to expire, then the storage device sends a notification to the requesting host, as indicated in block 370. By way of example, this notification includes, but is not limited to, “queue full” notice or a “busy” notice. Flow then ends at block 380.

The following example provides one exemplary illustration. A storage system is processing requests from five different hosts and is currently operating at 70% of its maximum performance capacity. Each request, as it arrives, is time-stamped. No further action is taken for requests that complete normally. Then, the storage device records a host request to abort an existing request that is currently being processed in the storage system. After, the storage system completes the abort operation, it computes the elapsed time from when the request arrived to when the request was aborted. In this example, the time was five seconds. The storage device also records various parameters noted above in connection with block 270 of FIG. 2.

Assume further that over time, ten of these aborted requests from the same host occur after five seconds of elapsed time. Further, all of these requests were aborted at times when the storage system workload was greater than 65% of maximum.

At this juncture, once the storage device determines that it has a sufficient amount of data for this host, the storage device more effectively manages I/O requests from the host. For instance, at some future time, the storage device observes a host request that matches the profile of previous requests that were aborted before they completed. The current workload in the array is at 75% of maximum. The storage device sets an internal timer that will run for approximately 4.9 seconds before it rings. It then submits the request to the storage system for processing. When the 4.9 second timer rings, the storage device determines if the command has completed. If the command has not completed, the storage device will internally abort the command and return a status to host indicating that the request could not be completed in a timely manner. In doing so, the storage device has prevented a timeout from occurring on the request in the host system (which would have resulted in a failover). The host system waits a small amount of time and re-sends the request. By this time, the workload in the array has decreased to the point that the re-submitted request completes in two seconds or less. Here, the application's I/O has completed and no failover has occurred in the multi-path software.

Exemplary embodiments reduce the number of failovers and consequently the occurrence of re-sends along multiple different communication paths. Thus, one exemplary embodiment provides a single point in the path that requests travel from applications to storage. Further, exemplary embodiments can simultaneously manage hosts using very short timeouts and hosts using normal or long timeouts.

Embodiments in accordance with the present invention are not limited to any particular type or number of databases, storage device, storage system, and/or computer systems. The storage system, for example, includes one or more of various portable and non-portable computers and/or electronic devices, servers, main frame computers, distributed computing devices, laptops, and other electronic devices and systems whether such devices and systems are portable or non-portable.

As used herein, the term “storage device” means any data storage device capable of storing data including, but not limited to, one or more of a disk array, a disk drive, a tape drive, optical drive, a SCSI device, or a fiber channel device.

In one exemplary embodiment, one or more blocks or steps discussed herein are automated. In other words, apparatus, systems, and methods occur automatically. As used herein, the terms “automated” or “automatically” (and like variations thereof) mean controlled operation of an apparatus, system, and/or process using computers and/or mechanical/electrical devices without the necessity of human intervention, observation, effort and/or decision.

The methods in accordance with exemplary embodiments of the present invention are provided as examples and should not be construed to limit other embodiments within the scope of the invention. For instance, blocks in diagrams or numbers (such as (1), (2), etc.) should not be construed as steps that must proceed in a particular order. Additional blocks/steps may be added, some blocks/steps removed, or the order of the blocks/steps altered and still be within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method of software execution, comprising:
recording a first time when an input/output (I/O) request is received from a host computer in a storage area network (SAN);
recording a second time when an abort for the I/O request is received from the host computer; and
calculating a timeout time based on the first and second times to predict when the host computer will abort a subsequent I/O request.

2) The method of claim 1 further comprising, sending the host computer a notification of (1) queue full or (2) busy, before expiration of the timeout time.

3) The method of claim 1 further comprising, preventing the host computer from resending the I/O request along a different network path by sending a notice to the host computer before expiration of the timeout time.

4) The method of claim 1 further comprising:
sending the I/O request from the host computer to an array controller coupled to a disk array;
generating a timestamp for the first time when the array controller receives the I/O request.

5) The method of claim 1 further comprising, sending a status to the host computer that the subsequent I/O request cannot be completed in a timely manner if the subsequent I/O request is not completed before expiration of the timeout time.

6) The method of claim 1 further comprising, preventing the host computer from timing-out and initiating a failover by notifying the host computer that the subsequent I/O request cannot be processed within the timeout time.

7) The method of claim 1 further comprising, adjusting the timeout time after receiving plural aborts from the host computer.

8) A computer readable medium having instructions for causing a computer to execute a method, comprising:
calculating, by a storage device, a time for a host computer to abort data requests in a storage network;
receiving a data request at the storage device from the host computer; and
sending, by the storage device, the host computer a notice of a status of the data request before the time expires and the host computer aborts the data request.

9) The computer readable medium of claim 8 further comprising, sending the status as one of a queue busy or queue full notification.

10) The computer readable medium of claim 8 further comprising, preventing the host computer from resending the data request along a different pathway by sending the notice.

11) The computer readable medium of claim 8 further comprising, observing command abort operations and failover events occurring at the host computer to calculate the time for the host computer to abort the data requests.

12) The computer readable medium of claim 8 further comprising, reducing a number of failover events at the host computer by sending the notice before the host computer aborts data requests.

13) The computer readable medium of claim 8 further comprising, when the host computer aborts a data request, then recording (1) a type of the data request and (2) at least one request parameter.

14) The computer readable medium of claim 8 further comprising, when the host computer aborts a data request, then recording whether the aborted data request is part of a serial access pattern or a random access pattern.

15) The computer readable medium of claim 8 further comprising, when the host computer aborts a data request, then recording an amount of time that the aborted data request was outstanding in the storage device before being aborted.

16) A computer system, comprising:
a memory for storing an algorithm; and
a processor for executing the algorithm to:
receive a first input/output (I/O) request from a host at an array controller in a storage system;
calculate a time period for the host to abort the first I/O request;
receive a second I/O request from the host; and
send a notice to the host if the array controller cannot process the second I/O request before expiration of the time period.

17) The computer system of claim 16, wherein the processor further executes the algorithm to prevent the host from initiating a failover event by sending the host the notice.

18) The computer system of claim 16, wherein the processor further executes the algorithm to record an indication of how busy the array controller is when the host aborts the first I/O request.

19) The computer system of claim 16, wherein the processor further executes the algorithm to report to the host that the array controller is normally functioning if the array controller cannot process the second I/O request before expiration of the time period.

20) The computer system of claim 16, wherein the processor further executes the algorithm to cause the host to (1) avoid a failover event and (2) resend the second I/O request along a same network path to the array controller.
